(19) United States
(12) Patent Application Publication
(10) Pub. No.: US 2009/0314484 A1
(43) Pub. Date: Dec. 24, 2009

(54) Standalone flow rate controller for controlling flow rate of cooling or heating fluid through a heat exchanger

(75) Inventors: Kevin Barrett, Edmond, OK (US); Alan F. Niles, Gig Harbor, WA (US)

Correspondence Address: MORGAN LEWIS & BOCKIUS LLP, 1111 PENNSYLVANIA AVENUE NW, WASHINGTON, DC, 20004, US

(73) Assignee: AKZ Technologies LLC

(21) Appl. No.: 12/213,345

(22) Filed: Jun. 18, 2008

(51) Int. Cl. G05D 23/00

(52) U.S. Cl. 165/293

(57) ABSTRACT

A standalone flow rate controller for controlling flow rate of cooling or heating fluid through a heat exchanger by providing a control signal to a flow valve actuator so as to open or close a flow valve in response thereto. A first temperature sensor measures an entry temperature of the cooling or heating fluid flowing into the heat exchanger and a second temperature sensor measures an exit temperature of the cooling or heating fluid flowing out of the heat exchanger. A control unit is responsive to a temperature difference between the entry temperature and the exit temperature for adjusting the control signal so as maintain the temperature difference substantially constant.

### FIELD OF THE INVENTION

The present invention relates generally to flow control valves and more specifically to a load matched flow control valve for improved performance of fluid heating and cooling devices while saving pump energy at the same time.

### BACKGROUND OF THE INVENTION

Flow control valves that serve to vary fluid flow based on an input from a control device that senses room temperature or refrigerant pressure are well known. Such valves eliminate the need for system flow balancing and reduce main pump energy. Typically such valves operate in a fully open or fully closed state under the control of a thermostat that measures room temperature and provides a control signal for opening or closing the valve. A drawback associated with conventional flow control valves is the difficulty in accurately matching the heating or cooling capacity of the device to the load it sees from the space it has to condition. Space heating or cooling units have a predetermined maximum thermal capacity that is specified by the manufacturer at a maximum fluid flow rate. When a heating engineer designs a heating or cooling installation, he selects the most appropriate unit based on the area of the space to be served by the unit. So a small area will obviously require a unit of smaller thermal capacity than a large area. But generally heating engineers design for worst-case conditions, as a result of which under normal (i.e. non-worst conditions) the selected unit is over-capacity. This is why in conventional installations people freeze in the summer and swelter in the winter. Another problem with conventional flow control valves is that failure to reduce the cooling capacity of a coil results in increased humidity and a greater chance of mold and mildew developing. Furthermore, control devices based on refrigerant pressure require access to the refrigerant. This can result in refrigerant leaks damaging the equipment and the environment and requires a separate valve for each refrigerant. Such devices are not ideally suitable for improving the performance of fluid heating and cooling devices while saving pump energy at the same time.

Flow rate valve controllers that serve to maintain constant temperature in space heating and cooling systems are known. Such flow rate valve controllers are responsive to the ambient air temperature in the space being controlled for opening and closing the flow rate valve in order to maintain substantially constant space temperature. In simple controllers, the flow rate valve is fully open or fully closed but in more sophisticated controllers of this type proportional control is employed whereby the flow rate valve may be continuously adjusted so as to constantly adjust the flow rate.

U.S. Pat. No. 5,335,708 is an example of a flow rate valve controllers using proportional control for fluid cooling of a mainframe computer. This patent discloses a cooling apparatus having a heat exchanger for performing heat exchange between cooling water and fluid, and a flow rate regulator valve for regulating a flow rate of either the cooling water or the fluid which pass through the heat exchanger. A desired cooling temperature of the fluid is preset. A temperature of the cooled fluid is detected, and an opening degree of the flow rate regulator valve is set according to a difference between the detected temperature and the preset temperature. Simultaneously, either a temperature difference of the cooling water and the fluid or a flow rate of the cooling water is detected. The opening degree of the flow rate regulator valve is corrected or compensated for on the basis of a result of the detection, thus enabling suitable temperature control of the fluid in accordance with a variation of the temperature or flow rate of the cooling water.

In one embodiment, the temperature of the fluid at the inlet of the heat exchanger and the flow rate of the cooling water are assumed to be constant, and the flow rate of the fluid is adjusted in order to maintain a desired temperature of the fluid. It will be recalled, in this case, that the fluid temperature is analogous to the air temperature in a conventional space heating/cooling system.

The system described by U.S. Pat. No. 5,335,708 is thus intended to maintain a constant temperature of a fluid from a heat exchanger when the temperature on the other side of the exchanger varies. To this end, it requires sensors on both sides of the heat exchanger: one for measuring the temperature of the cooling water and the other for measuring the temperature of the fluid that is cooled by the cooling water.

### SUMMARY OF THE INVENTION

In accordance with the invention there is provided an improved load-matched flow control valve device that can be utilized for improved performance of fluid heating and cooling devices while saving pump energy at the same time.

To this end, the invention provides a standalone flow rate controller for controlling flow rate of cooling or heating fluid through a heat exchanger, said standalone flow rate controller comprising:

a control output port for providing a control signal to a flow valve actuator so as to open or close a flow valve in response thereto;

a first sensor input port for coupling a first temperature sensor adapted to measure an entry temperature of the cooling or heating fluid flowing into the heat exchanger;

a second sensor input port for coupling a second temperature sensor adapted to measure an exit temperature of the cooling or heating fluid flowing out of the heat exchanger; and

a control unit coupled to each of the control output port, the first sensor input port, and the second sensor input port and being responsive to a temperature difference between the entry temperature and the exit temperature for adjusting said control signal so as maintain the temperature difference substantially constant.

The control unit is typically a suitably programmed microprocessor that controls an actuator for modulating the fluid flow based on the respective temperatures at the entry and exit apertures of the valve as measured by respective temperature sensors. The actuator may be retrofitted to an off-the-shelf valve such as a ball valve or gate valve or other commercially available valve suitable for the fluid being controlled, so as to adjust the valve according to the control received from the control board. A pair of solid state sensors plug into the controller and are selectably controlled by the control unit for measuring the entry and exit temperatures of the fluid entering and leaving pipes of the heat exchanger being controlled.

Unlike known systems such as above-mentioned U.S. Pat. No. 5,335,708, the present invention is concerned not with the relationship between the temperature of the water entering the heat exchanger and that of the fluid cooled but is based on the temperature differential across the heat exchanger coil. Thus, the system according to the invention uses sensors on the coil side of the heat exchanger only. Since the load seen by heat exchangers can vary as in the case of a fan coil in an occupied space, it is never sized correctly to meet this load. So, while U.S. Pat. No. 5,335,708 does vary the flow rate this is done in order to maintain a constant fluid (i.e. ambient) temperature. The controller according to the present invention does not maintain the ambient fluid temperature but only the temperature differential across the heat exchanger coil.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram showing an embodiment of a space heating/cooling system having a flow valve controlled by a control unit according to the invention;

FIG. 2 is a flow diagram showing initial actions carried out by the control unit;

FIGS. 3a and 3b are flow diagrams showing the principal actions carried out by the control unit in cooling and heating modes of operation, respectively, when the heat exchanger employs a water source heat pump; and

FIGS. 4a and 4b are flow diagrams showing the principal actions carried out by the control unit in cooling and heating modes of operation, respectively, when the heat exchanger employs a fan coil.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### DETAILED DESCRIPTION OF EMBODIMENTS

In the following description of some embodiments, identical components that appear in more than one figure or that share similar functionality will be referenced by identical reference symbols.

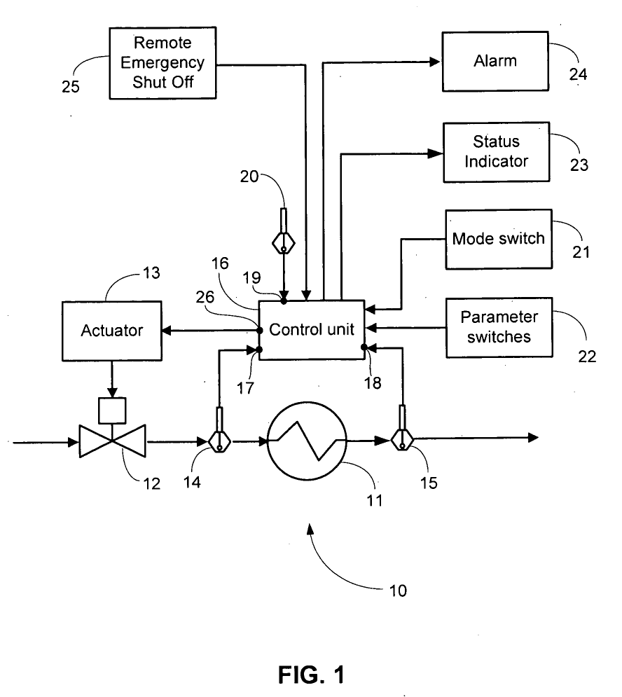

FIG. 1 shows schematically a heating/cooling system 10 comprising a heat exchanger 11 coupled to a fluid load-matched flow control valve 12 that is actuated via an actuator 13. The heat exchanger 11 has an input pipe through which cold or hot water flows to which heat is either input from the environment or from which heat is extracted to the environment. This may be done using either a fan coil or a water source heat pump. Fluid flow through the heat exchanger 11 is assumed to be from left to right as denoted via an arrow. In accordance with the invention, a first temperature sensor 14 is attached to the fluid pipe as it enters the heat exchanger 11, and a second temperature sensor 15 is attached to the fluid pipe as it leaves the heat exchanger 11. The valve 12 is controlled by a microprocessor-based control unit 16 mounted on a control board (not shown). The control unit 16 operates in accordance with a stored algorithm for modulating fluid flow based on the measured entry and exit fluid temperatures from the heat exchanger. The valve 12 may be a ball valve or gate valve or other commercially available valve suitable for the fluid being controlled. The actuator 13 may also be a commercially available device such as a powered-open powered-closed actuator, a powered-open spring-close actuator, or a floating point control actuator that adjusts the valve according to the control received from the control board. The temperature sensors 14 and 15 are solid state sensors are attached to the fluid entry and exit pipes of the heat exchanger using a suitable fastener such as clips, clamps, tie-wraps etc.

The control unit 16 is designed to accept voltages from 12 to 277 volts, both AC and DC and either 50 or 60 HZ and includes connections for providing the control and the power for the actuator. The control unit 16 also includes respective sensor inlets 17 and 18 for coupling to the respective temperature sensors at the entry and exit of the heat exchanger. Additional inlets allow for connection of inputs from an external device such as a cooling signal, a heating signal or an activation signal. Thus, in the figure there is shown an activation port 19 to which an external thermostat 20 may be connected. The control unit 16 further includes a first selector switch 21 constituting a mode switch for selecting whether the heat exchanger 11 is based on a water coil or a water source heat pump, and a second selector switch 22 for setting a required temperature differential to be achieved. These parameters are set according to the type and capacity of the heat exchanger with which the control unit 16 is used and, once set, do not need further adjustment. The selector switches 21 and 22 are therefore conveniently realized by DIP switches mounted in the control unit 16. The control unit 16 provides a control signal to the actuator 13 for controlling the valve 12. The control board within the control unit 16 may be mounted in any type of enclosure that conforms to the pertinent standards and may be coated with a conformal coating to protect it from water and corrosion. The inputs and outputs may be connected using plug-in connectors, push-on connectors or terminal strips. The control unit 16 may be provided with status indicator lamps 23 or other indication means to indicate the status of the control unit, such as whether or not the control unit 16 is active, and if it is active whether it is in “Heating Mode” or “Cooling Mode”. Likewise a visual and/or audible “Alarm” indicator 24 may be provided for indicating a malfunction. The control unit 16 is also responsive to an emergency shut-off signal provided by a remote emergency shut-off unit 25 for shutting down completely in case of an emergency, such as a fire.

The control unit 16 may have a connection to allow it to communicate with a building automation system. Such a system may provide activation and provide feedback to the building automation system, whereby the control unit 16 will provide an output signal to the valve 12 that typically has a rating in the range of 4 to 20 mA, 0 to 10 volts DC, 24 volts AC or any other voltage that is commonly available. The control of the actuator 13 and valve 12 is matched so that control is as linear as possible. This linearity is provided via the algorithm in the control unit 16.

The valve 12 may be any commercially available valve used for controlling fluid flow such as a ball, gate, or butterfly valve. The valve is matched to the control board listed above to provide as linear a control as possible. Typically, the valve has a manual device to override the controls to allow it to be opened and closed manually.

The sensors may be N- or P-type thermistors or integrated circuit solid state sensors that are attached to the pipes with a thermal conducting paste and sense the fluid in and out temperatures. Alternatively, they may be mounted in a well inserted in the pipe. The connecting wire can be any length from one inch (25 mm) to 100 feet (30 m) and is calibrated to work with the control board.

The control unit 16 may be a standalone device that is adapted for retrofitting to a conventional control valve and actuator, thus allowing the benefits of the invention to be realized also in existing installations. In this case, the controller may be mounted remotely in an enclosure and a control output port 26 connected to the actuator, which may be mounted on the valve or adjacent to it and connected via a linkage. Alternatively, the actuator 13 and the control unit 16 both mounted on the control board may be integral with the valve 12 so as to form an independent unit that merely requires installation and connection of the sensors 14 and 15. In either case, the control unit 16 operates in accordance with a custom algorithm that matches the components for optimum performance and the valve 12 operates independent of any central controller as is common in advanced building installations. Different algorithms are employed depending on whether the heat exchanger employs a water source heat pump or a fan coil and these algorithms will therefore be described separately.

In both embodiments, the control unit 16 is responsive to an actuation or de-actuation signal that is determined by the central thermostat 20 and in accordance with which the control unit 16 is either actuated or de-actuated. The thermostat is typically located in a space to be controlled so that when the heat exchanger is in cooling mode, the control unit 16 is inoperative if the ambient temperature is lower than a preset temperature, while when the heat exchanger is in heating mode, the control unit 16 is inoperative if the ambient temperature is higher than a preset temperature. Otherwise, the control unit 16 is actuated in order to perform proportional control of the cooling/heating fluid flow rate in accordance with the following logic. The de-actuation signal is referred to below as “no call for operation” while the actuation signal is referred to below as “call for operation”. In both heating and cooling modes, the control unit 16 maintains the differential temperature between the fluid entering the heat exchanger and the fluid leaving the heat exchanger at a constant value. This value is preset using DIP switches 22 according to the capacity of the heat exchanger. he control unit maintains and vice versa not really—typically a single differential is used regardless of capacity of heat exchanger

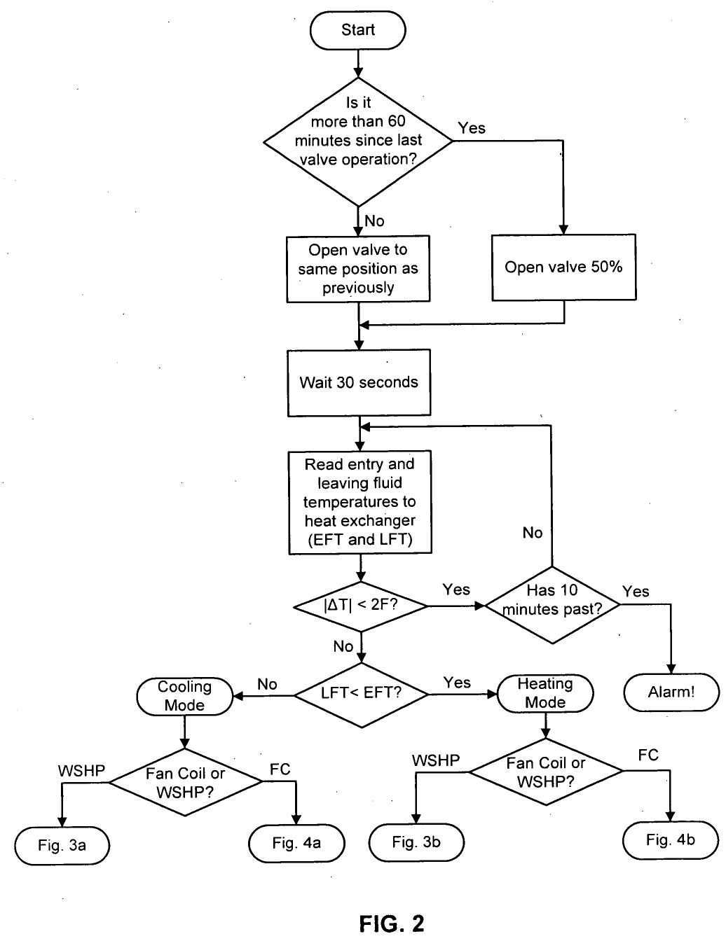

### No Call for Operation (FIG. 2)

When there is no call for operation owing to de-actuation by the thermostat, the valve modulates to the fully closed position sufficiently slowly to eliminate “water hammer”, typically no faster than 30 seconds.

### Call for Operation (FIG. 2)

Upon a call for operation, the valve 12 modulates to the 50% open position within 2 seconds (fast opening feature), and remains at this position for 30 seconds.
The differential temperature between the entry fluid (EFT) and the leaving fluid (LFT) is now monitored.
If the absolute temperature differential is less than a preset value such as 2° F. over a protracted time period, such as 3 to 10 minutes, this is indicative of a fault: control is stopped and an alarm is, given. The time period is preset using the DIP switches 19.
Otherwise, after 30 seconds, measure the Leaving Fluid Temperature (LFT) and the Entering Fluid Temperature (EFT). If LFT>EFT, follow the Cooling Mode Sequence, otherwise follow the Heating Mode Sequence according to the type of heat exchanger in use, as explained below.

### Fluid Cooled/Heated Water Source Heat Pump

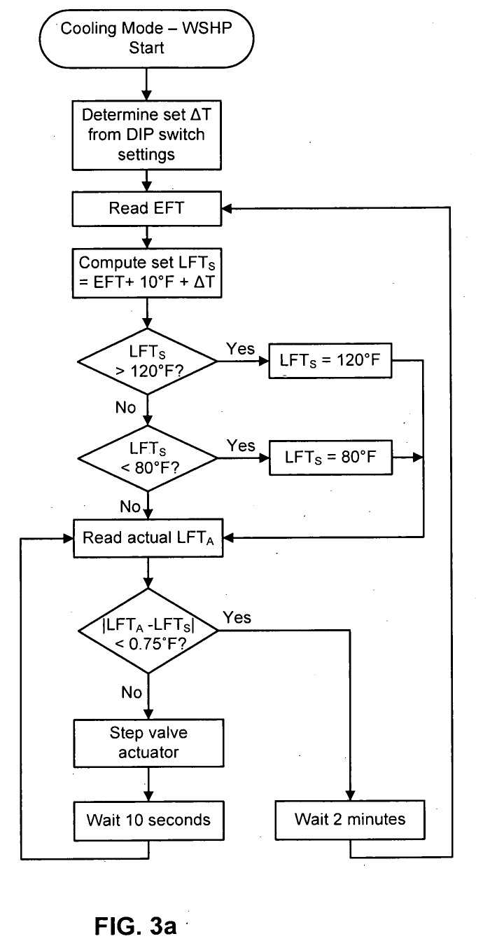

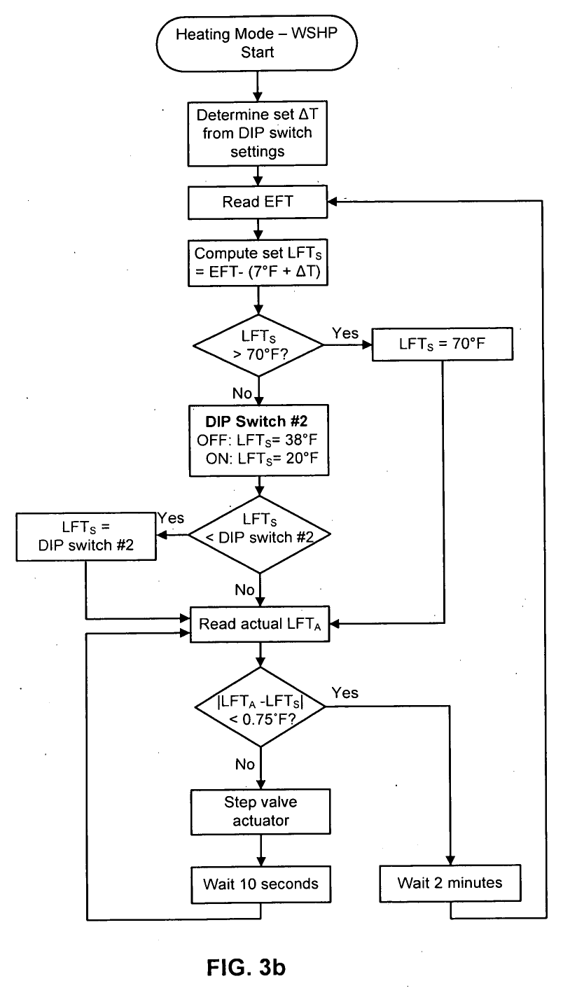

Cooling Mode Sequence (FIG. 3a):
Begin modulating the valve to maintain the difference between the LFT and the EFT equal to the preset value for the heat exchanger in use as set by the DIP switches 19. The preset temperature difference is maintained using a direct, slow acting, self tuning PID (Proportional Integral Differential) control. In accordance with one embodiment, the control is realized as follows. Once every 10 seconds, the EFT value is measured, and the desired set-point temperature of the leaving fluid (LFT_{S}) is calculated based on the desired temperature differential ΔT, for example, LFT_{S}=EFT+10° F.+ΔT. The actual LFT value is measured and compared with the calculated value, LFT_{S}.
If they are the same within a range of ±0.75° F., no signal is fed to the actuator so that the valve remains at its current setting and the cycle is repeated after a time interval of 2 minutes.
Otherwise, a control signal is fed to the actuator, which modulates the valve using PID, and the cycle is repeated after a time interval of 10 seconds.
If the calculated LFTsp value is above 120° F., then modulate the valve to maintain a maximum LFTsp of 120° F. Likewise, if the calculated LFTsp value is below 80° F., then modulate the valve to maintain a minimum LFTsp of 80° F.
Otherwise, refresh PID loop every 10 seconds when EFT value is refreshed. If LFT increases to 130° F., then increase flow to maximum, if temperature does not fall then activate an alarm.

Heating Mode Sequence (FIG. 3b):
Begin modulating valve to maintain the difference between the LFT and the EFT equal to the preset value for the heat exchanger in use as set by the DIP switches 19. The preset temperature difference is maintained using a Reverse Acting, Slow acting, self, tuning PID control. In accordance with one embodiment, the control is realized as follows. Once every 10 seconds, the EFT value is measured, and the desired set-point temperature of the leaving fluid (LFT_{S}) is calculated based on the desired temperature differential ΔT, for example, LFT_{S}=EFT−(7° F.+ΔT).
If the calculated LFTsp value is above 70° F., then the valve is modulated to maintain a maximum LFTsp of 70° F.
If the calculated LFTsp is below 38° F. or 20° F. depending on the setting of the appropriate DIP switch 19, then the minimum value of LFTsp is set to 38° F. or 20° F., as appropriate.
If the calculated LFTsp value is within the normal range, the actual LFT value is measured and compared with the calculated value, LFT_{S}, and control continues normally whereby the step valve is actuated and a 10 second wait implemented.
If they are the same within a range of +0.75° F., no signal is fed to the actuator so that the valve remains at its current setting and the cycle is repeated after a time interval of 2 minutes.
Otherwise, a control signal is fed to the actuator, which modulates the valve using PID, and the cycle is repeated after a time interval of 10 seconds.

### Fluid Cooled/Heated Fan Coil

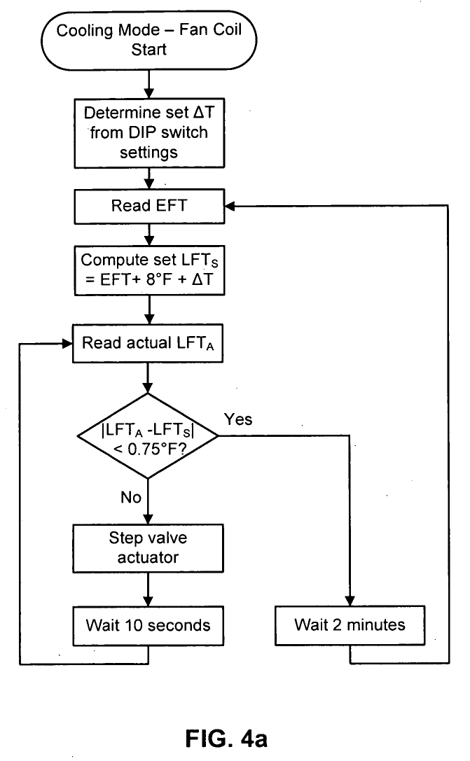

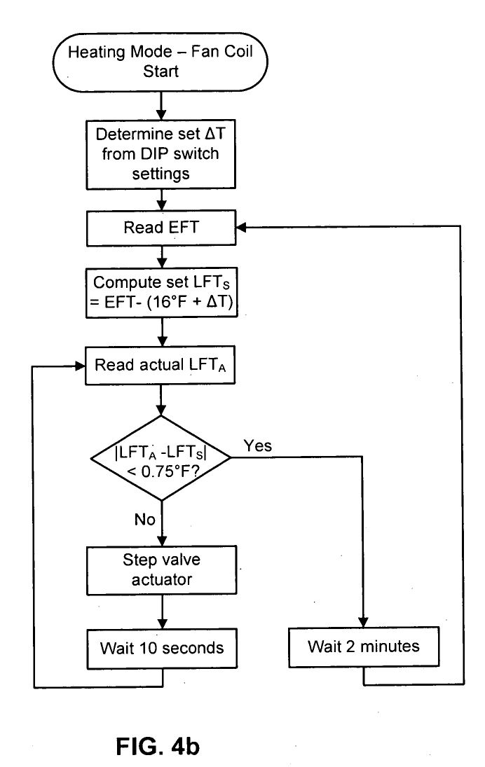

Cooling Mode Sequence (FIG. 4a):
Begin modulating the valve to maintain the difference between the LFT and the EFT equal to the preset value for the heat exchanger in use as set by the DIP switches 19. The preset temperature difference is maintained using a direct, slow acting, self tuning PID (Proportional Integral Differential) control. In accordance with one embodiment, the control is realized as follows. Once every 10 seconds, the EFT value is measured, and the desired set-point temperature of the leaving fluid (LFT_{S}) is calculated based on the desired temperature differential ΔT, for example, LFT_{S}=EFT+8° F.+ΔT. The actual LFT value is measured and compared with the calculated value, LFT_{S}.
If they are the same within a range of ±0.75° F., no signal is fed to the actuator so that the valve remains at its current setting and the cycle is repeated after a time interval of 2 minutes.
Otherwise, a control signal is fed to the actuator, which modulates the valve using PID, and the cycle is repeated after a time interval of 10 seconds.

Heating Mode Sequence (FIG. 4b):
Begin modulating the valve to maintain the difference between the LFT and the EFT equal to the preset value for the heat exchanger in use as set by the DIP switches 19. The preset temperature difference is maintained using a direct, slow acting, self tuning PID control. In accordance with one embodiment, the control is realized as follows. Once every 10 seconds, the EFT value is measured, and the desired set-point temperature of the leaving fluid (LFT_{S}) is calculated based on the desired temperature differential ΔT, for example, LFT_{S}=EFT−(16° F.+ΔT).
The actual LFT value is measured and compared with the calculated value, LFT_{S}.
If they are the same within a range of ±0.75° F., no signal is fed to the actuator so that the valve remains at its current setting and the cycle is repeated after a time interval of 2 minutes.
Otherwise, a control signal is fed to the actuator, which modulates the valve using PID, and the cycle is repeated after a time interval of 10 seconds.

### Calibration

In order to ensure that the actuation signal modulates the valve by the correct angular adjustment, the control unit must be calibrated for the valve being used. It will be borne in mind that, in one embodiment, the control unit may be retrofitted to an existing valve, in which case field calibration must be carried out. The control unit is calibrated as follows:
First define a fully open valve position as Pv=1, and fully closed valve position as Pv=0.
Compare Pv position to the measured values of LFT−EFT, and then scale the valve stem by a scale factor S corresponding to the number of ° F. per 0.1 revolution given by:

$$S = \{ \frac{LFT - EFT}{0.1 Pv} \}$$

For example, if at Pv=0.60 (60% open valve), the measured temperature difference is 6° F., then 0.1 revolution of the valve stem is given an initial value of 1° F. degree.
Update every 2 seconds by measuring LFT and modulating valve to new position Pv_{new} where:

$${Pv}_{new} = Pv + 10 \cdot ( \frac{{LFT}_{sp} - LFT}{S} )$$

When t=10 seconds, get new EFT.

### CONCLUSION

The control unit according to the present invention senses the temperature differential when the valve begins to open and determines if there is a temperature rise indicating cooling or a temperature drop indicating heating and then selects the mode of operation.

In normal operation the valve operates as follows:
The valve receives a signal from the thermostat or other input device to activate it.
The control unit quickly opens the valve and checks the temperature differential of the fluid entering and leaving the heat exchanger.
Based on the temperature differential it determines if the unit is in the heating mode or cooling mode.
The control unit modulates the valve to maintain a specified temperature differential. When the valve is driven Open, an open LED is illuminated; when the valve is driven closed a Closed LED is illuminated.
When the temperature set by the thermostat or other input device is achieved, the control unit powers the valve closed over a prolonged time period of up to 30 seconds.
If an alarm signal is received at the alarm terminals, then the control unit powers the valve closed and illuminates both OPEN and CLOSE LEDs to indicate that an alarm has been received.

It is to be understood that while various embodiments have been described, they are by way of example only and variations will be apparent to those skilled in the art. For example, in the embodiments as described, temperature differential (ΔT) is maintained by calculating a set point LFT based on the desired ΔT and comparing it with the measured LFT. However, it will be appreciated that the actual ΔT (possibly after normalization) can equally well be compared with a set-point value. All such embodiments as fall within the scope of the claims and their equivalents are intended to be encompassed by the present invention.

It will also be understood that while various time and temperature values have been specified, these are by way of example only and are not to be construed as limiting in any way the scope of the invention as defined by the annexed claims.

It is also to be understood that while the invention has been described with regard to use of heat exchangers using fan coils, the invention is equally suitable for use with other types of heat exchangers such as air handling units using air coils.

1. A standalone flow rate controller for controlling flow rate of cooling or heating fluid through a heat exchanger, said standalone flow rate controller comprising:
a control output port for providing a control signal to a flow valve actuator so as to open or close a flow valve in response thereto;
a first sensor inlet for coupling a first temperature sensor adapted to measure an entry temperature of the cooling or heating fluid flowing into the heat exchanger;
a second sensor inlet for coupling a second temperature sensor adapted to measure an exit temperature of the cooling or heating fluid flowing out of the heat exchanger; and
a control unit coupled to each of the control output port, the first sensor input port, and the second sensor input port and being responsive to a temperature difference between the entry temperature and the exit temperature for adjusting said control signal so as maintain the temperature difference substantially constant.

2. The controller according to claim 1, including a selector switch for setting a required temperature differential to be achieved.

3. The controller according to claim 1, including a selector switch for selecting whether the heat exchanger is a fan coil or a water source heat pump.

4. The controller according to claim 1, including a status indicator for indicating a status of the controller.

5. The controller according to claim 1, including an alarm for providing an alarm in case of a malfunction.

6. The controller according to claim 1, including an actuation port for coupling an external actuation signal thereto for actuating the controller.

7. The controller according to claim 6, wherein the external actuation signal is provided by a thermostat.

8. The controller according to claim 6, being responsive to a de-actuation signal for modulating the valve to a fully closed position at a sufficiently slow rate to eliminate “water hammer”.

9. The controller according to claim 7, being responsive to a de-actuation signal for modulating the valve to a fully closed position at a sufficiently slow rate to eliminate “water hammer”.

10. The controller according to claim 1, being responsive to an actuation signal for very quickly modulating the valve to a half-open position and remaining at this position for a prolonged period.

11. The controller according to claim 1, being adapted to:
monitor the differential temperature between the entry fluid (EFT) and the leaving fluid (LFT);
output an alarm signal if the absolute temperature differential is less than a preset value over a preset time period; and
otherwise, after preset time period, measure the LFT and the EFT and execute a Cooling Mode Sequence if LFT>EFT or a Heating Mode Sequence otherwise.

12. The controller according to claim 11, wherein the Cooling Mode Sequence and the Heating Mode Sequence are responsive to parameters that are preset according to type and capacity of the heat exchanger.

13. The controller according to claim 1, wherein the control unit, the actuator and the flow valve form an integral unit.
